(19) United States
(12) Patent Application Publication
(10) Pub. No.: US 2007/0168444 A1
(43) Pub. Date: Jul. 19, 2007

(54) Method for automatically initiating an instant messaging chat session based on a calendar entry

(76) Inventors: Yen-Fu Chen, Austin, TX (US); John Hans Handy-Bosma, Cedar Park, TX (US); Mei Yang Selvage, Pocatello, ID (US); Keith Raymond Walker, Austin, TX (US)

Correspondence Address: IBM CORP (YA);C/O YEE & ASSOCIATES PC, P.O. BOX 802333, DALLAS, TX, 75380, US

(21) Appl. No.: 11/334,228

(22) Filed: Jan. 18, 2006

(51) Int. Cl. G06F 15/16

(52) U.S. Cl. 709/207

(57) ABSTRACT

A computer implemented method, data processing system, and computer program product for automatically initiating an instant messaging (IM) chat session based on a calendar entry. A user's IM client receives instructions to initiate an IM chat session based on a scheduled entry in the calendaring system. These instructions may be received from the user's calendaring system or a continuously running service, such as a daemon, independent of the IM client. Upon receiving the instructions, the IM client may optionally alert the user to the impending chat session. The IM client then presents a chat window for the instant messaging chat session to the user at a time specified in the scheduled entry. Data associated with the scheduled entry in the calendaring system, such as notes or attachments related to the chat session, may also be displayed in the chat window.

### BACKGROUND OF THE INVENTION

1. Field of the Invention

The present invention relates generally to an improved data processing system, and in particular, the present invention provides a computer implemented method, data processing system, and computer program product for initiating an instant messaging chat session based on an entry in a calendaring system.

2. Description of the Related Art

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool.

Although instant messaging systems allow users to communicate with each other in real-time, these existing instant messaging systems have several deficiencies with regard to managing instant message communications. Consider the example of a business conference chat session comprising a board chair who has a weekly conference call and invites members of his team to the conference chat. Currently, the most efficient way for the board chair to invite his team members is for the board chair to have a group in his contact list that includes the members of that team. Then, in some instant messaging clients, such as Lotus® Sametime, the board chair can right-click the group and select “invite to chat”. Although, this existing method allows the board chair to invite currently available members to the conference chat, the limitation of this approach is that the board chair must perform the steps above each week in the board chair's instant messaging client in order to initiate the conference chat. In addition, if a team member becomes available after the chat, the board chair must send a personal invitation to the now-available team member. Consequently, the board chair must periodically check his contact list during the chat session for member availability, wait for each contact to ask to be invited, or set an alert on each contact's availability.

Therefore, it would be advantageous to have a computer implemented method, data processing system, and computer program product for overcoming the deficiencies in the existing art by providing a mechanism for automatically initiating an instant messaging chat session based on an entry in a calendaring system.

### SUMMARY OF THE INVENTION

Embodiments of the present invention provide a computer implemented method, data processing system, and computer program product for automatically initiating an instant messaging chat session based on a calendar entry. A user's instant messaging client may receive instructions to initiate an instant messaging chat session based on a scheduled entry in the calendaring system. These instructions may be received from the user's calendaring system or a continuously running service, such as a daemon, independent of the instant messaging client. Upon receiving the instructions, the instant messaging client may optionally alert the user to the impending chat session at the scheduled time of the chat or prior to the chat. The instant messaging client then presents a chat window for the instant messaging chat session to the user at a time specified in the scheduled entry. Data associated with the scheduled entry in the calendaring system, such as notes or attachments related to the chat session, may also be displayed in the chat window.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram illustrating a data processing system in which the present invention may be implemented;

FIG. 3 is a block diagram illustrating components used in managing messages in accordance with an illustrative embodiment of the present invention;

FIG. 4 is a diagram illustrating an instant messaging client in accordance with an illustrative embodiment of the present invention;

FIG. 5 is an exemplary graphical user interface (GUI) of an instant messaging chat alarm in accordance with an illustrative embodiment of the present invention;

FIG. 6 is an exemplary instant messaging chat window provided to a user in accordance with an illustrative embodiment of the present invention; and

FIG. 7 is a flowchart of a process for automatically initiating an instant messaging chat session based on a calendar entry in accordance with an illustrative embodiment of the present invention.

### DETAILED DESCRIPTION OF THE PREFERRED EMBODIMENT

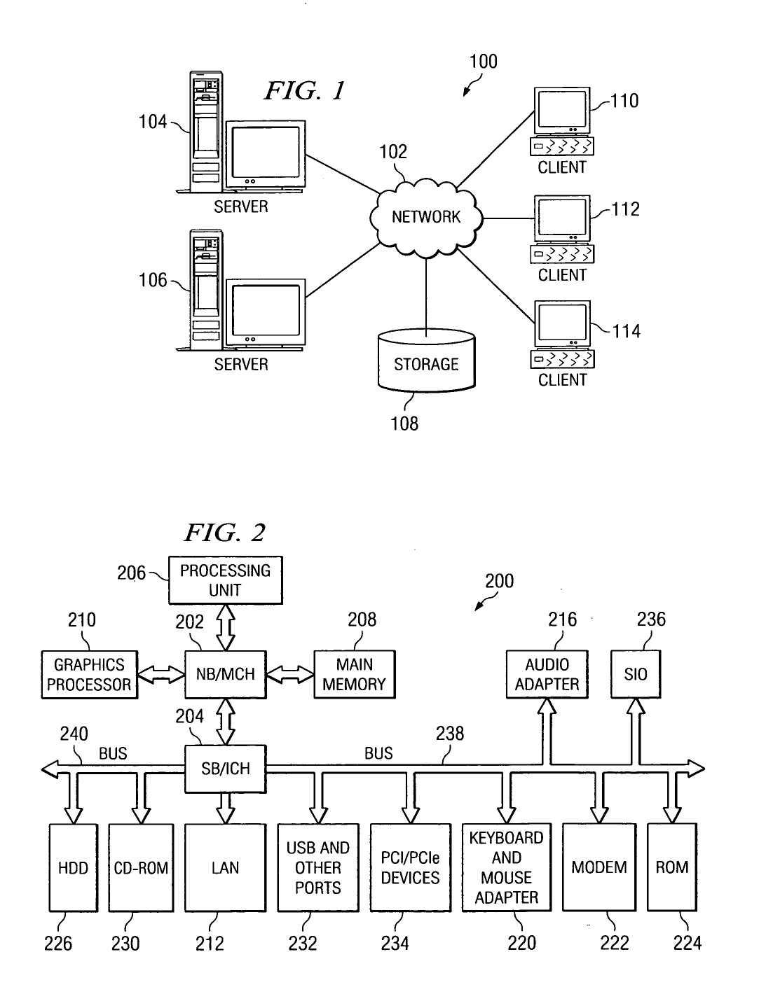

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Embodiments of the present invention provide an instant messaging system that allows instant messaging clients to increase their ability to manage instant messaging communications. The mechanism of the present invention enables instant messaging chat sessions to be opened on a user's screen based on a scheduled entry in the calendaring system. The mechanism of the present invention automates the task of initiating a chat or conference chat window by allowing a user's calendaring system or a continuously running service such as a daemon to instruct the user's instant messaging client to open up an instant messaging chat window at a scheduled meeting time specified in the calendar entry.

Aspects of the present invention also allow information associated with the calendar entry to be displayed in the chat window when the chat window is initiated. The information displayed may include traditional chat data, such as displaying the names of the chat attendees, as well as additional information, such as the topic assigned to the chat session and notes related to or attachments associated with the chat session. The information may have been stored in and associated with the calendar entry when the calendar entry was created. Thus, when the chat window is opened, properties within the chat window may be populated with the traditional chat information and the additional chat information in the calendar entry. In this manner, information the user has specified in the calendar entry regarding the instant messaging chat session may be used to display additional details regarding the chat to the user and to remind the user of what needs to be discussed in the chat session.

The chat initiating mechanism of the present invention may be configured to operate according to priorities that specify when a chat session may be initiated on a user's computer. For example, these priorities may include deferring the initiation of chat windows based on characteristics of the user or contacts. Examples of characteristics of the user include the user's location and online status. Examples of characteristics of the contacts are location, online status, organizational hierarchy in relation to the user, and association within a contact list group. Therefore, the user may give priority to superiors in an organization, or to members of the user's “Family” group, or based on current availability. The chat initiating mechanism may also obey popup and chat rules, such as “do not disturb” mode. However, an option to bypass these rules may be provided to accommodate the situation where users have already agreed to participate in the chat session in advance.

Furthermore, the instant messaging client may also be provided with the ability to persistently check the status of those contacts who were not online when the conference chat started. For example, the invention may automatically send an invite to a chat to a contact when a contact, who was not present when the chat started, now is online. Consequently, the user is not required to constantly monitor the user's contact list to determine if a contact is now online, nor does the user have to send an invite to the contact to join the chat.

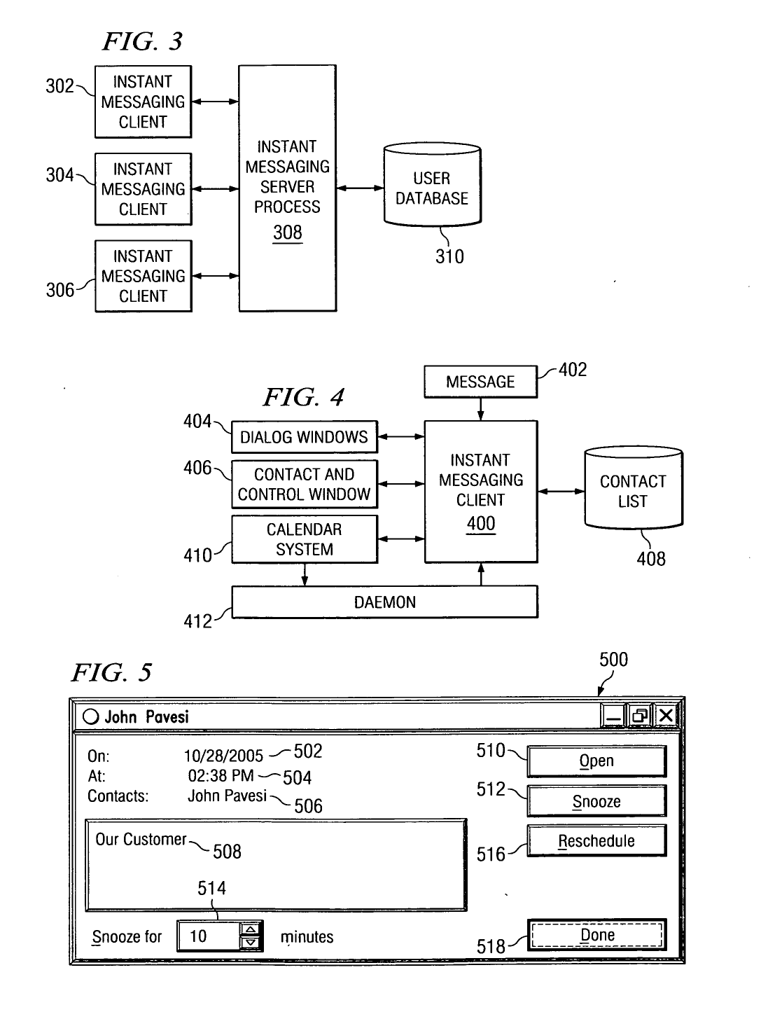

Turning now to FIG. 3, a block diagram illustrating components used in an instant messaging system in accordance with a preferred embodiment of the present invention is shown. In this illustrative example, a user at instant messaging client 302 may send or exchange messages with other users at instant messaging clients 304 and 306. These instant messaging clients may be executing on a data processing system, such as data processing system 200 in FIG. 2. The exchange of messages in these examples is facilitated through instant messaging server process 308. This process allows for users to find other users within the instant messaging system as well as aid in the exchange of messages between different users.

Depending on the particular instant messaging system, instant messaging server process 308 may only be involved in providing an indication of when particular users are online and for establishing initial contacts while users contacting users already on a buddy list may contact those users directly after seeing that a particular user is online. Instant messaging server process 308 may be located on a server, such as servers 104 or 106 in FIG. 1.

In these examples, the different users registered to the instant messaging system are stored in user database 310. This user database provides information needed to search for and find other users as well as contact users when they are online.

Turning next to FIG. 4, a diagram illustrating an instant messaging client is depicted in accordance with a preferred embodiment of the present invention. The components illustrated in FIG. 4 may be found in an instant messaging client, such as instant messaging clients 302, 304, or 306 in FIG. 3. These components may be implemented in a data processing system, such as data processing system 200 in FIG. 2.

In the illustrative example, instant messaging client 400 processes messages, such as message 402, received from users located on remote data processing systems. As messages are received, these messages are presented in dialog windows 404. Additionally, dialog windows 404 provide an interface for a user to input text to send messages to other users.

Contact and control window 406 is presented by instant messaging client 400 to provide the user with a list of user names, as well as other information. Contact and control window 406 also provides an interface to allow a user to set different preferences. For example, the user may set passwords required to access different names used in instant messaging sessions.

Also, a user may employ contact and control window 406 to set other preferences, such as colors and fonts used in instant messaging client 400. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 406 is stored in contact list 408 in these examples. Additional user or screen names may be added to or deleted from contact list 408. This contact list is employed in presenting the list of names within contact and control window 406.

Calendar system 410 may be used to invoke the mechanism of the present invention in various ways. In a first implementation, calendar system 410 may instruct the instant messaging client to initiate the instant messaging chat session. If the instant messaging client is not running when the calendaring system initiates the chat session, the calendaring system may launch the instant messaging client as well. This particular implementation requires that the calendaring system integrate with the instant messaging client via a plugin or adapter. The mechanism of the present invention may use the instant messaging client's existing application programming interface (API) to enable the instant messaging client to open an instant messaging window based on a calendar entry. The instant messaging client must also allow other programs, such as calendar system 410, to launch the instant messaging client and open a chat window. For example, at a particular time specified in the calendaring system, the calendaring system launches the instant messaging client and instructs the instant messaging client to open an instant messaging window and start a chat session with the contacts specified in the scheduled entry in the calendaring system. The calendaring system also provides the instant messaging client with other information stored in the calendaring entry, such as notes or documents related associated with the chat, and the instant messaging client may display this additional information within the chat window.

In a second implementation, if the instant messaging client is running, the instant messaging client itself may initiate the scheduled chat session. In this case, the instant messaging client may have a database for synching the calendar data from the calendaring system, and a subset of internal calendar functions that uses the calendar data to initiate the chat session at the scheduled time.

In a third implementation, a combination of the first and second implementations may be used to invoke the initiation of a scheduled chat session. A simple coordination between the calendaring system and instant messaging client may be used to ensure that the programs do not invoke the same chat session twice.

In a fourth implementation, continuously running service 412, such as a daemon in Unix® terminology, independent of the instant messaging client may be used to initiate the chat session. This particular implementation is beneficial since it is not necessary to make modifications to either the calendaring system or the instant messaging client. In addition, this implementation does not require that either the calendaring system or the instant messaging client be running. The service may have a database for synching the calendar data from the calendaring system, and a subset of internal calendar functions that uses the calendar data to initiate the chat session at the scheduled time.

In addition to initiating the scheduled chat session, calendar system 410 may also enable reminders or alarms of a scheduled chat to be provided to the user at the time of the scheduled chat, and prior to the scheduled chat time (e.g., 5 minutes before the chat time, 10 minutes before, etc.). These reminders may be in the form of visual, audio, tactile, or other alerts. The user may set a time in the calendar entry that specifies when the user wants to be reminded of the impending chat. When the user is alerted to the scheduled chat, the user may also be provided with the ability to modify the chat session, such as by canceling the chat, delaying the chat, or rescheduling the chat for another time.

FIG. 5 is an exemplary graphical user interface (GUI) of an instant messaging chat reminder in accordance with an illustrative embodiment of the present invention. Graphical user interface 500 may optionally be provided to the user if the user wants to receive an alarm prior to the scheduled time of the chat session. In one embodiment, graphical user interface 500 is always provided to the user at the scheduled time. In an alternative embodiment, the graphical user interface may be provided to the user based on the contact's online status, such as only when contact's status indicates the contact is online or the contact is now available. In a third embodiment, if the graphical user interface is shown to the user at the scheduled time or prior to the scheduled time, an “open when available” selectable button or checkbox may be included in the reminder window that allows the user to specify that the chat session should be started when the contact becomes available. The graphical user interface may be provided to the user via an instant messaging application, such as instant messaging client 400, in FIG. 4.

In the illustrative example in FIG. 5, graphical user interface 500 comprises an alarm window that alerts the user to an impending scheduled chat session. The alarm window may communicate information regarding the scheduled chat to the user, such as date 502 of the scheduled chat session, the scheduled time 504, contacts 506 who are to attend, and topic 508 of the chat. For example, graphical user interface 500 in this example communicates to the user that the user has a scheduled chat at 2:38 pm with John Pavesi regarding Our Customer.

Graphical user interface 500 may also include selectable buttons that allow the user to open the chat window to begin the chat session or modify the chat session, such as by canceling the chat, delaying the chat, or rescheduling the chat for another time. For example, “Open” or “Chat” button 510 may be included that, when selected, would open a chat window for the scheduled session with the appropriate contacts and properties such as notes, formatting, attachments, and the like. In a preferred embodiment, this button may be the default button. “Snooze” or “Delay” button 512 may be included to allow the user to delay the chat meeting. The button is accompanied by field 514 in which the user may specify a length of time before this dialog reappears. “Reschedule” button 516 may be used to reschedule the chat meeting for another time. “Done” or “Cancel” button 518 allows the user to indicate that the scheduled chat session has already taken place or will not be performed at all. By selecting this button, the scheduled chat window will not be opened and the user will not be reminded of the scheduled chat.

Although the example in FIG. 5 shows particular reminder options to alert the user, one of ordinary skill in the art would recognize that other alarm options may be used in graphical user interface 500 to provide the user with the capability to manage instant message communications.

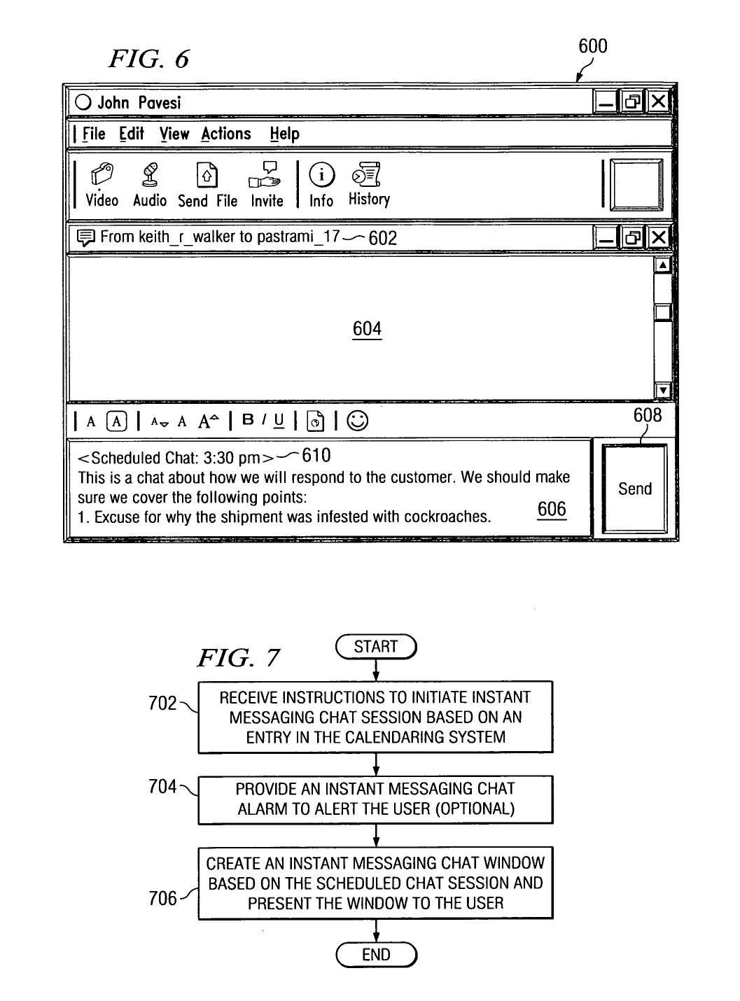

FIG. 6 is an exemplary instant messaging chat window provided to a user in accordance with an illustrative embodiment of the present invention. Instant messaging chat window 600 may be created by the instant messaging client at a time specified in the calendar entry for the scheduled chat session. Instant messaging chat window 600 may be presented to the user via the instant messaging application, such as instant messaging client 400, in FIG. 4.

Instant messaging chat window 600 may include properties present in a standard chat window, such as displaying the names of participants 602 in the chat session. The chat session in this example comprises a conversation between user keith_r_walker and the user's instant messaging contact, pastrami_{—}17, who in this example has been given a friendly name of John Pavesi in the user's contact list. The user may view the ongoing conversation in display area 604.

Instant messaging chat window 600 may also comprise text send box 606. When the instant messaging chat window is initiated, text send box 606 may be populated with information stored in or associated with the calendar entry, such as notes or attachments related to the chat session. In this example, text send box 606 has been populated with notes the user has entered in the calendar entry that define the content of the chat session and the details the participants need to discuss. As instant messaging chat window 600 behaves identically to a standard chat window at this point, the user may send, modify, or delete the notes in text send box 606 just as the user may do to any other text the user may potentially send. Thus, when the user selects “Send” button 608, the current content of the text send box is sent to the user's contact and displayed in display area 604 as well.

In one embodiment, instant messaging chat window 600 may indicate in some manner to the user that the chat session is a scheduled chat session. For example, a text line may be included in the text send box (e.g., <Scheduled Chat: 3:30 pm> 610) that specifies that the chat session was a scheduled chat session. This text line may be highlighted or presented in a color different from other text in text send box 606. A scheduled chat session indicator may also be added to the instant messaging window's title bar or in a status bar.

Turning now to FIG. 7, a flowchart of a process for automatically initiating an instant messaging chat session based on a calendar entry in accordance with an illustrative embodiment of the present invention. The process illustrated in FIG. 7 may be implemented in an instant messaging application, such as instant messaging client 400 in FIG. 4.

The process begins with the instant messaging client receiving an instruction to initiate an instant messaging chat session based on an entry in the calendaring system (step 702). For example, at a particular time specified in the calendaring system, the calendaring system may instruct the instant messaging client to create instant messaging chat session with the contacts specified in the scheduled entry in the calendaring system. If the instant messaging client is not running, the calendaring system may also launch the instant messaging client. The instant messaging client itself may initiate the scheduled chat session if the instant messaging client has internal calendaring functions that may use calendar data obtained from the calendaring system to initiate the chat session at the scheduled time. A continuously running service independent of the instant messaging client may initiate the chat session and instruct the instant messaging client to open a chat window if the service has internal calendaring functions that may use calendar data obtained from the calendaring system to initiate the chat session at the scheduled time.

Upon initiating the instant messaging chat session, in an optional step, the user may be provided with an instant messaging chat alarm (step 704). For instance, a reminder dialog window may be provided to the user at the time of the scheduled chat, and prior to the scheduled chat time. The instant messaging chat alarm may also enable the user to modify the chat session, such as by canceling the chat, delaying the chat, or rescheduling the chat for another time.

At the scheduled time in the calendar entry, the instant messaging client creates an instant messaging chat window for the scheduled chat session to the user (step 706). The instant messaging chat window behaves the same as a standard chat window at this point, and the user may begin a conversation with the participants of the chat session. An indication that the instant messaging chat window is based on a scheduled chat session may be displayed on the chat window. The instant messaging chat window may comprise standard chat window features, as well as include chat data in the form of notes associated with the calendar entry. The user may send these notes to the other chat participants, or modify or delete the notes.

Thus, the mechanism of the present invention allows instant messaging clients to increase their ability to manage instant messaging communications. The advantages provided by the mechanism of the present invention over current instant messaging systems include enabling chat sessions to be opened on a user's screen based on a scheduled entry in the calendaring system. The mechanism of the present invention automates tasks of initiating chat sessions by allowing a user's calendaring system or a continuously running service such as a daemon to instruct the user's instant messaging client to open up an instant messaging chat window at a scheduled meeting time specified in a calendar entry.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and digital video disc (DVD).

A data processing system is suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in an instant messaging client for initiating an instant messaging chat session, the computer implemented method comprising:
receiving an instruction to initiate the instant messaging chat session based on a scheduled entry in a calendaring system; and
presenting a chat window for the instant messaging chat session to a user at a time specified in the scheduled entry.

2. The computer implemented method of claim 1, further comprising:
persistently checking a status of one or more participants unavailable during the instant messaging chat session; and
automatically sending an invitation to join the instant messaging chat session when an unavailable participant becomes available.

3. The computer implemented method of claim 1, wherein the chat window is presented to the user only when a status of the participant indicates the participant is available.

4. The computer implemented method of claim 1, wherein data associated with the scheduled entry in the calendaring system is displayed in the chat window, and wherein the data includes at least one of topic information, notes, or attachments associated with the calendar entry.

5. The computer implemented method of claim 1, wherein the instruction to initiate the instant messaging chat session is received from one of a calendaring system or a daemon independent from the instant messaging client.

6. The computer implemented method of claim 5, wherein the calendaring system launches the instant messaging client if the instant messaging client is not running.

7. The computer implemented method of claim 5, wherein the daemon obtains calendar data from the calendaring system and uses the calendar data to initiate the instant messaging chat session at the time specified in the scheduled entry.

8. The computer implemented method of claim 1, further comprising:
providing an alarm to the user, wherein the alarm alerts the user to the impending instant messaging chat session.

9. The computer implemented method of claim 8, wherein the alarm is one of a visual, audio, tactile alarm.

10. The computer implemented method of claim 8, wherein the alarm provided to the user enables the user to cancel, delay, or reschedule the instant messaging chat session.

11. The computer implemented method of claim 1, wherein the instant messaging chat window may be initiated based on priorities, and wherein the priorities include at least one of deferring the initiation of the instant messaging chat window based characteristics of the user, or deferring the initiation of the instant messaging chat window based on characteristics of a user's contacts.

12. The computer implemented method of claim 1, wherein the initiation of the instant messaging chat window is performed according to existing popup and chat rules.

13. The computer implemented method of claim 12, wherein the existing popup and chat rules are bypassed when users agree to participate in the instant messaging chat session in advance.

14. A data processing system for initiating an instant messaging chat session, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive an instruction to initiate the instant messaging chat session based on a scheduled entry in a calendaring system, and present a chat window for the instant messaging chat session to a user at a time specified in the scheduled entry.

15. The data processing system of claim 14, wherein the processing unit further executes the computer usable code to persistently check a status of one or more participants unavailable during the instant messaging chat session, and automatically send an invitation to join the instant messaging chat session when an unavailable participant becomes available.

16. The data processing system of claim 14, wherein the chat window is presented to the user only when a status of the participant indicates the participant is available.

17. The data processing system of claim 14, wherein data associated with the scheduled entry in the calendaring system is displayed in the chat window, and wherein the data includes at least one of topic information, notes, or attachments associated with the calendar entry.

18. A computer program product for initiating an instant messaging chat session, the computer program product comprising:
a computer usable medium having computer usable program code tangibly embodied thereon, the computer usable program code comprising:
computer usable program code for receiving an instruction to initiate the instant messaging chat session based on a scheduled entry in a calendaring system; and
computer usable program code for presenting a chat window for the instant messaging chat session to a user at a time specified in the scheduled entry.

19. The computer program product of claim 18, further comprising:
computer usable program code for persistently checking a status of one or more participants unavailable during the instant messaging chat session; and
computer usable program code for automatically sending an invitation to join the instant messaging chat session when an unavailable participant becomes available.

20. The computer program product of claim 18, wherein the chat window is presented to the user only when a status of the participant indicates the participant is available.
